(19) United States
(12) Patent Application Publication
(10) Pub. No.: US 2007/0230051 A1
(43) Pub. Date: Oct. 4, 2007

(54) Perpendicular magnetic recording medium and magnetic storage device

(75) Inventors: Antony Ajan, Kawasaki (JP); Toshio Sugimoto, Kawasaki (JP); Ryosaku Inamura, Kawasaki (JP); Daiju Kaneko, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/474,522

(22) Filed: Jun. 26, 2006

(30) Foreign Application Priority Data
Mar. 31, 2006 (JP) 2006-100594

(51) Int. Cl. G11B 5/74; G11B 5/66

(52) U.S. Cl. 360/131; 428/828.1; 428/829; 428/831.2

(57) ABSTRACT

A perpendicular magnetic recording medium is disclosed that is able to prevent the Wide Area Track Erasure phenomenon from occurring and is capable of high density recording. The perpendicular magnetic recording medium includes a substrate; a soft-magnetic backup stack structure including a first magnetic layer, a first non-magnetic coupling layer, and a second magnetic layer stacked on the substrate in order; an intermediate layer formed from a non-magnetic material on the soft-magnetic backup stacked structure; and a recording layer on the intermediate layer, the recording layer having an easy axis of magnetization perpendicular to the surface of the substrate. The first magnetic layer and the second magnetic layer are formed from a poly-crystal soft-magnetic material, each of the first magnetic layer and the second magnetic layer has an easy axis of magnetization in the surface thereof, and the magnetization of the first magnetic layer and the magnetization of the second magnetic layer are coupled and anti-parallel to each other.

### CROSS-REFERENCE TO RELATED APPLICATION

This patent application is based on Japanese Priority Patent Application No. 2006-100594 filed on Mar. 31, 2006, the entire contents of which are hereby incorporated by reference.

### BACKGROUND OF THE INVENTION

1. Field of the Invention

The present invention relates to a perpendicular magnetic recording medium and a magnetic storage device.

2. Description of the Related Art

Magnetic storage devices are widely used in various apparatuses from large scale systems to computers for personal use and communication devices. In all kinds of applications of the magnetic storage devices, it is required to further increase the recording density and the data transmission speed.

In recent years, in an in-plane recording technique, which is a primary magnetic recording method at present, a recording layer having a high coercive force (namely, having high thermal stability of residual magnetization) is employed in order to prevent loss of information recorded at a high recording density. In order to further increase the recording density, it is necessary to further increase the coercive force, and accordingly, it is necessary to increase the strength of the magnetic field for recording of a magnetic recording head. For this purpose, it is required to use a soft magnetic material having a high saturation magnetic flux density in the magnetic pole of the magnetic head. However, such a soft magnetic material is not readily available; thus, it is difficult to increase the recording density of a magnetic recording device.

On the other hand, in a perpendicular magnetic recording technique, since the recording layer of a magnetic recording medium is magnetized in a direction perpendicular to a surface of a substrate, the recorded information can hardly be lost compared to the in-plane recording technique. For this reason, it is possible to obtain a higher recording density than the in-plane recording technique.

In a perpendicular magnetic recording medium, a backup layer formed from a soft magnetic material is applied on a substrate, and on the backup layer a recording layer is stacked. When recording information in the perpendicular magnetic recording medium, the magnetic field of the magnetic head is applied perpendicularly on the film surface of the recording layer, and the magnetic field returns to the magnetic head by passing through the soft magnetic material backup layer. The soft magnetic material backup layer forms a pair with the magnetic head to absorb and expel the magnetic field. In the soft magnetic material backup layer, if a magnetic wall is formed therein, the magnetic field leaking from the magnetic wall may be detected by a reproduction head, and this causes noise spikes, and may cause errors.

To reduce the noise spikes, it is proposed that the soft magnetic material backup layer be formed by stacking two soft magnetic material layers with a non-magnetic layer in between so as to form a magnetic structure with the two soft magnetic material layers being coupled by anti-ferromagnetic coupling. For example, Japanese Laid-Open Patent Application No. 2001-155322, Japanese Laid-Open Patent Application No. 2002-358618, and Japanese Laid-Open Patent Application No. 2001-331920 disclose inventions related to this technique.

In such a magnetic structure, the magnetization in one soft magnetic material layer is anti-parallel to the magnetization in the other soft magnetic material layer; thus, the magnetic field leakages from the magnetic walls of respective soft magnetic material layers cancel out each other, and this prevents generation of the noise spike. In addition, since it is possible to prevent formation of magnetic domains, amorphous materials can be used to form the soft magnetic material layers.

However, in the perpendicular magnetic recording medium, a so-called Wide Area Track Erasure (WATER) phenomenon arises. The Wide Area Track Erasure is a phenomenon in which when information is repeatedly recorded in the same track, information from the recorded track to tracks a few microns apart disappears. When the Wide Area Track Erasure phenomenon arises, the recorded information is lost, and the long-term reliability of the perpendicular magnetic recording medium declines.

### SUMMARY OF THE INVENTION

The present invention may solve one or more of the problems of the related art.

A preferred embodiment of the present invention may provide a perpendicular magnetic recording medium and a magnetic storage device able to prevent the Wide Area Track Erasure phenomenon from occurring and capable of high density recording.

According to a first aspect of the present invention, there is provided a perpendicular magnetic recording medium, comprising:

a substrate;

a soft-magnetic backup stack structure including a first magnetic layer, a first non-magnetic coupling layer, and a second magnetic layer stacked on the substrate in order;

an intermediate layer formed from a non-magnetic material on the soft-magnetic backup stacked structure; and

a recording layer on the intermediate layer, said recording layer having an easy axis of magnetization perpendicular to the surface of the substrate,

wherein

the first magnetic layer and the second magnetic layer are formed from a poly-crystal soft-magnetic material,

each of the first magnetic layer and the second magnetic layer has an easy axis of magnetization in the surface thereof, and a magnetization of the first magnetic layer and a magnetization of the second magnetic layer are coupled while being anti-parallel to each other.

According to the present invention, the soft-magnetic backup stack structure includes the first magnetic layer and the second magnetic layer with the first non-magnetic coupling layer in between, and the first magnetic layer and the second magnetic layer are formed from a poly-crystal soft-magnetic material. Because the first magnetic layer and the second magnetic layer are formed from a crystal material, it is possible to improve the crystallinity and the crystalline alignment of the recording layer via the intermediate layer, and this enhances the perpendicular coercive force of the recording layer, and improves the magnetic property of the recording layer.

In addition, since the first magnetic layer and the second magnetic layer are coupled with each other by anti-ferromagnetic coupling, the magnetic field leakages from these magnetic layers cancel out each other. Thus, it is possible to reduce the magnetic field leakage from the soft-magnetic backup stack structure, and prevent noise from being detected by the reproduction element; as a result, the SN (Signal-to-Noise) ratio of the perpendicular magnetic recording medium can be improved. Consequently, it is possible to perform high density recording in the perpendicular magnetic recording medium.

Further, since the first magnetic layer and the second magnetic layer of the soft-magnetic backup stack structure are formed from a crystal material, it is possible to set the saturation magnetic flux density of the first magnetic layer and the second magnetic layer to be higher than that of an amorphous soft magnetic material; this enhances the exchange coupling magnetic field, and prevents the Wide Area Track Erasure phenomenon from occurring.

According to a second aspect of the present invention, there is provided a magnetic storage device, comprising:

a recording and reproduction unit having a magnetic head; and

a perpendicular magnetic recording medium,

wherein

the perpendicular magnetic recording medium includes

a substrate;

a soft-magnetic backup stack structure including a first magnetic layer, a first non-magnetic coupling layer, and a second magnetic layer stacked on the substrate in order;

an intermediate layer formed from a non-magnetic material on the soft-magnetic backup stacked structure; and

a recording layer on the intermediate layer, said recording layer having an easy axis of magnetization perpendicular to the surface of the substrate,

wherein

the first magnetic layer and the second magnetic layer are formed from a poly-crystal soft-magnetic material,

each of the first magnetic layer and the second magnetic layer has an easy axis of magnetization in the surface thereof, and a magnetization of the first magnetic layer and a magnetization of the second magnetic layer are coupled while being anti-parallel to each other.

According to an embodiment of the present invention, there is provided a magnetic storage device capable of high density recording and able to prevent the Wide Area Track Erasure phenomenon from occurring, and has good long-term reliability.

These and other objects, features, and advantages of the present invention will become more apparent from the following detailed description of the preferred embodiments given with reference to the accompanying drawings.

### BRIEF DESCRIPTION OF THE DRAWINGS

FIG. 1 is a schematic cross-sectional view illustrating an example of a perpendicular magnetic recording medium according to a first embodiment of the present invention;

FIG. 2A and FIG. 2B are plan views illustrating crystalline states and magnetizations of the poly-crystal soft magnetic layers 19 and 21 of the perpendicular magnetic recording medium 10 according to the first embodiment of the present invention;

FIG. 3 is a schematic cross-sectional view illustrating another example of a perpendicular magnetic recording medium according to the first embodiment of the present invention;

FIG. 4 is a schematic cross-sectional view illustrating still another example of a perpendicular magnetic recording medium according to the first embodiment of the present invention;

FIG. 5 shows experimental results of X-ray diffraction on crystal orientation of the perpendicular magnetic recording medium of the present example;

FIG. 6 is a table showing properties of the perpendicular magnetic recording medium of the present example and examples for comparison 1 and 2; and

FIG. 7 is a schematic view of a principal portion of a magnetic storage device 50 according to a second embodiment of the present invention.

### DESCRIPTION OF THE PREFERRED EMBODIMENTS

Below, preferred embodiments of the present invention are explained with reference to the accompanying drawings.

### First Embodiment

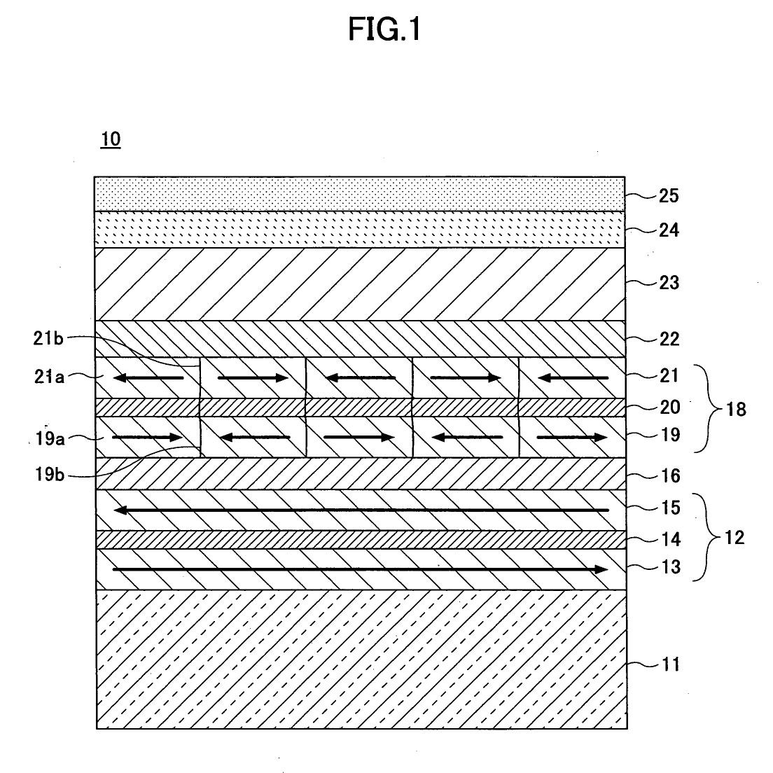

FIG. 1 is a schematic cross-sectional view illustrating an example of a perpendicular magnetic recording medium according to a first embodiment of the present invention.

As illustrated in FIG. 1, a perpendicular magnetic recording medium 10 includes a substrate 11, and a first backup layer 12, a separation layer 16, a second backup layer 18, an intermediate layer 22, a recording layer 23, a protection film 24, and a lubrication layer 25 stacked on the substrate 11 in order.

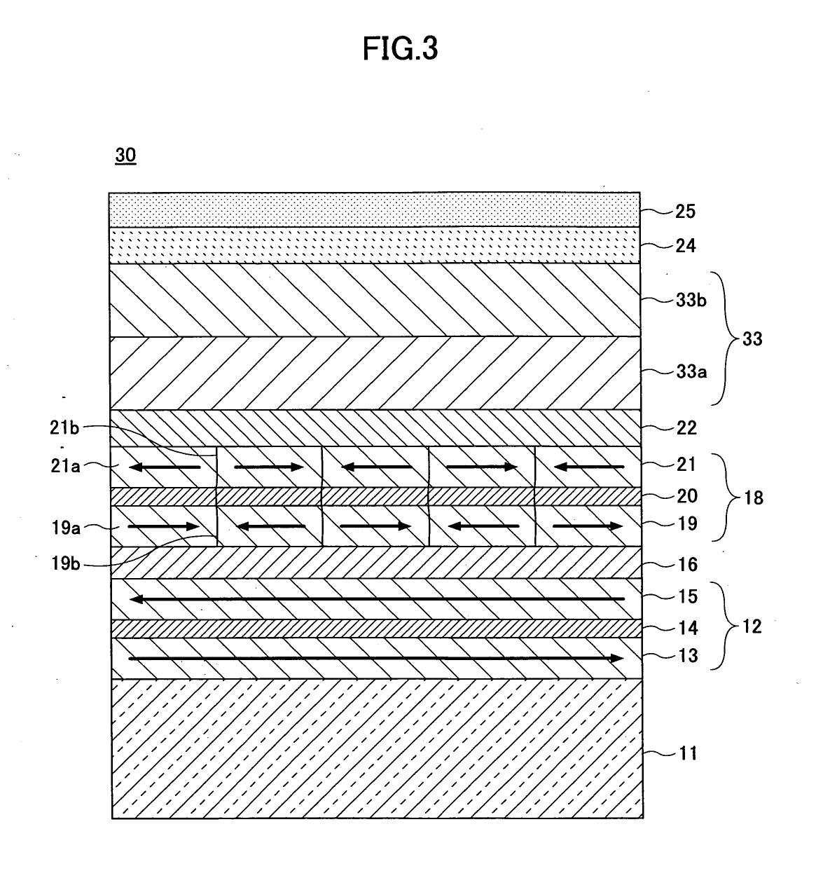

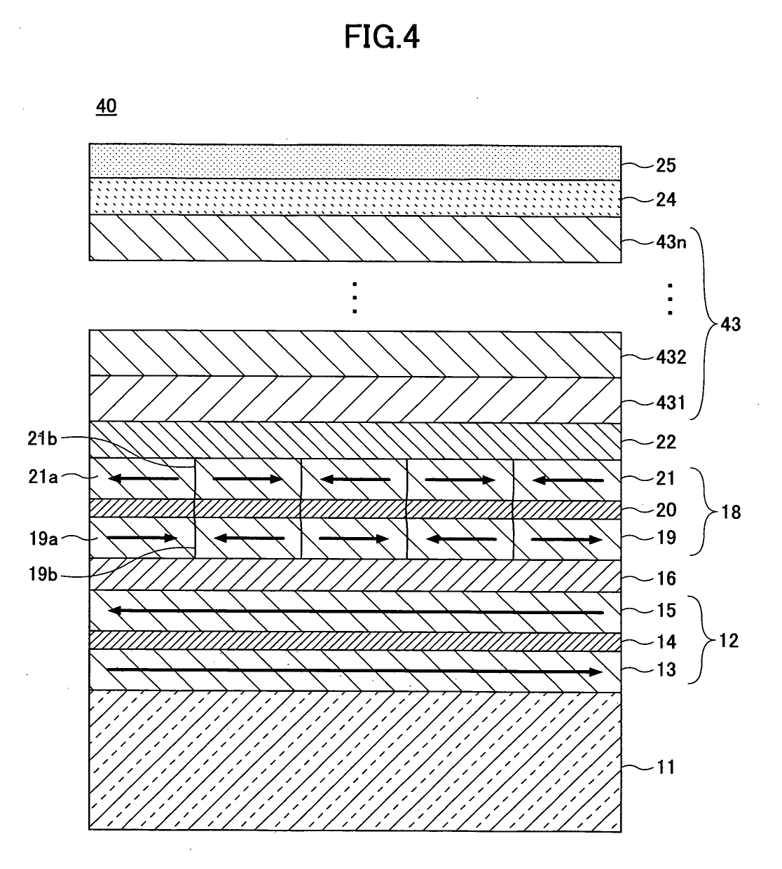

In FIG. 1, the directions of the arrows in the first backup layer 12 and the second backup layer 18 schematically indicate the directions of the easy axes of magnetizations, and the orientations of the arrows indicate the orientations of the residual magnetizations, that is, when an external magnetic field is not applied. In the following FIG. 3 and FIG. 4, the definition of the arrows is the same as that in FIG. 1.

Continuing explanation with reference to FIG. 1, the first backup layer 12 includes an amorphous soft magnetic layer 13 and an amorphous soft magnetic layer 15, and a non-magnetic coupling layer 14 in between. The second backup layer 18 includes a poly-crystal soft magnetic layer 19 and a poly-crystal soft magnetic layer 21, and a non-magnetic coupling layer 20 in between.

The substrate 11, for example, may be a plastic substrate, a crystallized glass substrate, a strengthened glass substrate, a silicon substrate, or an aluminum alloy substrate.

When the perpendicular magnetic recording medium 10 is a magnetic disk, the substrate 11 has a disk shape. When the perpendicular magnetic recording medium 10 is a magnetic tape, the substrate 11 may be formed by a PET (polyethylene terephthalate) film, a PEN (polyethylene naphthalate) film, or heat-resistant polyimide (PI).

In the magnetic backup layer 12, each of the amorphous soft magnetic layer 13 and the amorphous soft magnetic layer 15, for example, is 50 nm-2 μm in thickness, and is formed from an amorphous soft material including at least one of Fe, Co, Ni, Al, Si, Ta, Ti, Zr, Hf, V, Nb, C, and B. More specifically, the amorphous soft magnetic layer 13 and the amorphous soft magnetic layer 15 may be formed from materials such as FeSi, FeAlSi, FeTaC, CoNbZr, CoCrNb, CoFeB, and NiFeNb.

The magnetizations of the amorphous soft magnetic layer 13 and the amorphous soft magnetic layer 15 are coupled by anti-ferromagnetic coupling through the non-magnetic coupling layer 14. Preferably, the easy axes of magnetizations of the amorphous soft magnetic layer 13 and the amorphous soft magnetic layer 15 are in the radial direction of the substrate 11. Due to this, in a residual magnetization state, the direction of the magnetization of the amorphous soft magnetic layer 13 and the direction of the magnetization of the amorphous soft magnetic layer 15 are toward the center of the substrate 11 and toward the periphery of the substrate 11, respectively, or to the contrary.

The amorphous soft magnetic layer 13 and the amorphous soft magnetic layer 15 may be formed from soft magnetic materials having compositions different from each other. Alternatively, the amorphous soft magnetic layer 13 and the amorphous soft magnetic layer 15 may be formed from soft magnetic materials having the same composition. In addition, preferably, the amorphous soft magnetic layer 13 and the amorphous soft magnetic layer 15 have comparable thicknesses. Due to this, the magnetic field leakages from the amorphous soft magnetic layer 13 and the amorphous soft magnetic layer 15 cancel out each other, and this prevents noise from being received by the reproduction element of the magnetic head.

The non-magnetic coupling layer 14 may be formed from a non-magnetic material including one of Ru, Cu, Cr, Rh, Ir, Ru alloys, Rh alloys, and Ir alloys. Preferably, the Ru alloy non-magnetic materials are alloys of Ru with one of Co, Cr, Fe, Ni, and Mn, or with alloys of Co, Cr, Fe, Ni, and Mn.

The thickness of the non-magnetic coupling layer 14 is in an appropriate range so that the amorphous soft magnetic layer 13 and the amorphous soft magnetic layer 15 are coupled by anti-ferromagnetic exchange coupling. For example, the thickness of the non-magnetic coupling layer 14 is in a range from 0.3 nm to 2.5 nm.

In the first backup layer 12, a stack layer including a non-magnetic coupling layer and an amorphous soft magnetic layer may be disposed on the amorphous soft magnetic layer 15. However, in this case, it is preferable that the net magnetization of the entire first backup layer 12 be nearly zero.

The separation layer 16, for example, is 2.0 nm-10 nm in thickness, and may be formed from an amorphous non-magnetic material including at least one of Ta, Zr, Ti, C, Mo, W, Re, Os, Hf, Mg, and Pt. Because the separation layer 16 is amorphous, it does not influence the crystal alignment of the poly-crystal soft magnetic layer 19 of the second backup layer 18, which is above the separation layer 16. Due to this, the poly-crystal soft magnetic layer 19 can be easily aligned in a self-organizing manner, and this improves the crystal alignment of the poly-crystal soft magnetic layer 19.

In addition, the separation layer 16 further makes the distribution of diameters of the crystal grains in the poly-crystal soft magnetic layer 19 uniform. Further, since the separation layer 16 is non-magnetic, it prevents magnetic coupling between the amorphous soft magnetic layer 15 and the poly-crystal soft magnetic layer 19.

In the second backup layer 18, each of the poly-crystal soft magnetic layer 19 and the poly-crystal soft magnetic layer 21 is formed from a crystal soft magnetic material. Because of this configuration, as described in the following examples, the crystallinity and the crystalline alignment of the intermediate layer 22 are improved, which is disposed on the poly-crystal soft magnetic layer 21.

In addition, when the poly-crystal soft magnetic layer 19 and the poly-crystal soft magnetic layer 21 are thicker, the crystallinity and the crystalline alignment of the intermediate layer 22 are better, and this makes it easier to avoid magnetic saturation caused by the recording magnetic field. From the point of view of enhancing the perpendicular coercive force and the nucleation field of the recording layer 23, and improving the S/N ratio, it is preferable for the total thickness of the poly-crystal soft magnetic layer 19 and the poly-crystal soft magnetic layer 21 to be less than 10 nm. Further, it is preferable for the thickness of each of the poly-crystal soft magnetic layer 19 and the poly-crystal soft magnetic layer 21 to be in the range from 1 nm to 5 nm. When the total thickness of the poly-crystal soft magnetic layer 19 and the poly-crystal soft magnetic layer 21 is greater than 10 nm, the perpendicular coercive force of the recording layer 23 increases too much, and the overwrite property of the recording layer 23 is apt to decline. However, even in this case, if the thickness of the intermediate layer 22 is reduced appropriately, increase of the perpendicular coercive force of the recording layer 23 and declination of the overwrite property of the recording layer 23 are preventable.

Each of the poly-crystal soft magnetic layer 19 and the poly-crystal soft magnetic layer 21 includes plural crystal grains 19a and 21a, and the crystal grains 19a and 21a are in close contact with each other via granular boundaries 19b and 21b.

The easy axis of magnetization of each of the poly-crystal soft magnetic layer 19 and the poly-crystal soft magnetic layer 21 is parallel to the surface of the substrate 11 (namely, in-plane), and is randomly orientated in-plane.

Preferably, each of the poly-crystal soft magnetic layer 19 and the poly-crystal soft magnetic layer 21 may be formed from one of Ni, NiFe, and NiFe alloys. When the poly-crystal soft magnetic layer 19 and the poly-crystal soft magnetic layer 21 are formed from Ni, or NiFe, or NiFe alloys, a (111) crystal plane becomes a growing plane. Due to this, when the intermediate layer 22, which is disposed on the poly-crystal soft magnetic layer 21, is formed from Ru or Ru alloys having a hcp crystalline structure (hexagonal closed packed), good lattice matching between the poly-crystal soft magnetic layer 21 and the intermediate layer 22 can be obtained. As a result, the crystallinity and the crystalline alignment of the intermediate layer 22 are improved, and further, the crystallinity and the crystalline alignment of the recording layer 23 are improved.

The NiFe alloys can be denoted as NiFe-X1, where the additive element X1 may be one or more of Cr, Ru, Si, O, N, and SiO₂. By adding the additive element X1 to NiFe, the saturation magnetic flux density can be reduced while maintaining the crystalline structure of NiFe. Thus even when the thicknesses of the poly-crystal soft magnetic layer 19 and the poly-crystal soft magnetic layer 21 deviate from a preset value, it is possible to prevent magnetic field leakage from the poly-crystal soft magnetic layer 19 and the poly-crystal soft magnetic layer 21, and reduce adverse influence of the deviated film thicknesses.

A NiFe—O film and a NiFe—N film can be formed by adding O₂ gas and N₂ gas to inert gas (such as Ar gas), which serves as the atmospheric gas when forming the poly-crystal soft magnetic layer 19 and the poly-crystal soft magnetic layer 21, and sputtering the NiFe—O film or the NiFe—N film by using a NiFe sputtering target. In this way, the NiFe—O film or the NiFe—N film becomes a poly crystal film having a good diameter distribution of the crystal grains. In this process, preferably, the O₂ gas or the N₂ gas is added at a volume concentration of 2% or less.

The non-magnetic coupling layer 20 may be formed from non-magnetic transition metals. Preferably, the non-magnetic coupling layer 20 may be formed from one of Ru, Cu, Cr, Rh, Ir, Ru alloys, Rh alloys, and Ir alloys because a relatively strong exchange coupling magnetic field is obtainable with these compositions. The Ru alloys can be obtained by adding at least one of Co, Cr, Fe, Ni, and Mn to Ru element.

The thickness of the non-magnetic coupling layer 20 is in an appropriate range so that the poly-crystal soft magnetic layer 19 and the poly-crystal soft magnetic layer 21 are coupled by anti-ferromagnetic exchange coupling. For example, the thickness of the non-magnetic coupling layer 20 is in a range from 0.4 nm to 2.5 nm.

When the non-magnetic coupling layer 20 is formed from a Ru film or a Ru alloy film, preferably, the thickness of the non-magnetic coupling layer 20 is in a range from 0.4 nm to 0.9 nm. When the non-magnetic coupling layer 20 is formed from a Cr film, preferably, the thickness of the non-magnetic coupling layer 20 is in a range from 0.6 nm to 1.2 nm. When the non-magnetic coupling layer 20 is formed from a Cu film, preferably, the thickness of the non-magnetic coupling layer 20 is in a range from 0.8 nm to 2.1 nm.

With the thickness of the non-magnetic coupling layer 20 in the above range, it is possible to enhance the exchange coupling magnetic field between the poly-crystal soft magnetic layer 19 and the poly-crystal soft magnetic layer 21. Due to this, it is possible to prevent the anti-parallel state of the magnetizations from being destroyed, and thus to prevent leakage of the magnetic field.

It should be noted that the dependence of the ranges of the thickness on the constituent elements of the non-magnetic coupling layer 20 is also applicable to the non-magnetic coupling layer 14.

If the residual magnetization and the thickness of the poly-crystal soft magnetic layer 19 are denoted by Mr1 and t1, respectively, and the residual magnetization and the thickness of the poly-crystal soft magnetic layer 21 are denoted by Mr2 and t2, respectively, it is preferable that the product of the residual magnetization and the thickness of the poly-crystal soft magnetic layer 19 be equal to the product of the residual magnetization and the thickness of the poly-crystal soft magnetic layer 21, namely, Mr1×t1=Mr2×t2. Due to this, the magnetic field leakages from the poly-crystal soft magnetic layer 19 and the poly-crystal soft magnetic layer 21 cancel out each other; this reduces noise caused by the second backup layer 18 and improves the S/N ratio. In addition, when the poly-crystal soft magnetic layer 19 and the poly-crystal soft magnetic layer 21 are formed from the same composition, it is preferable that their thicknesses be equal, namely, t1=t2. Due to this, it is easy to fabricate the poly-crystal soft magnetic layer 19 and the poly-crystal soft magnetic layer 21 because it is sufficient to just control the thickness of the poly-crystal soft magnetic layer 19 and the poly-crystal soft magnetic layer 21.

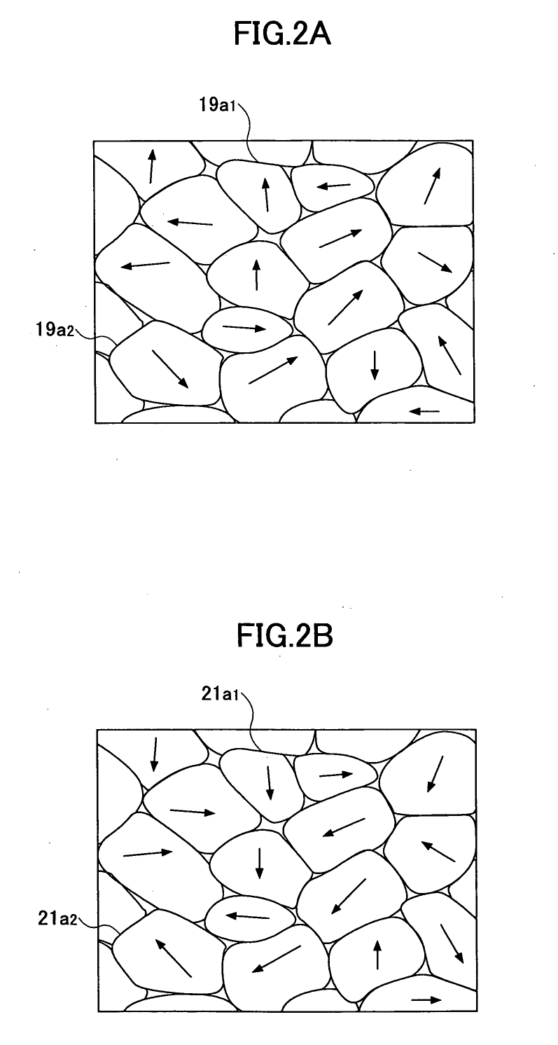

FIG. 2A and FIG. 2B are plan views illustrating crystalline states and magnetizations of the poly-crystal soft magnetic layers 19 and 21 of the perpendicular magnetic recording medium 10 according to the first embodiment of the present invention.

Specifically, FIG. 2A shows the crystalline states and magnetizations of the poly-crystal soft magnetic layer 19, and FIG. 2B shows the crystalline states and magnetizations of the poly-crystal soft magnetic layer 21.

In FIG. 2A and FIG. 2B, directions of arrows indicate the directions of the easy axes of magnetizations, and the orientations of the arrows indicate the orientations of the residual magnetization.

Referring to FIG. 2A, FIG. 2B, and FIG. 1, the poly-crystal soft magnetic layer 19 and the poly-crystal soft magnetic layer, 21 have nearly the same crystalline states. Namely, because the poly-crystal soft magnetic layer 21 grows on the poly-crystal soft magnetic layer 19 with the non-magnetic coupling layer 20 in between, the crystalline state of the poly-crystal soft magnetic layer 19 is directly reflected on the poly-crystal soft magnetic layer 21.

For example, a crystal grain 21a1 in FIG. 2B of the poly-crystal soft magnetic layer 21 grows on a crystal grain 19a1 in FIG. 2A of the poly-crystal soft magnetic layer 19 with the non-magnetic coupling layer 20 in between. Because the non-magnetic coupling layer 20 is very thin, the size and shape of the crystal grain 21a1 is nearly the same as that of the crystal grain 19a1.

In addition, the easy axis of magnetization of the crystal grain 21a1 is parallel to the easy axis of magnetization of the crystal grain 19a1. When an external magnetic field is not applied, that is, when observing the residual magnetization, the residual magnetization of the crystal grain 21a1 is anti-parallel to the residual magnetization of the crystal grain 19a1. Due to this, the magnetic field leakages from the crystal grain 21a1 and the crystal grain 19a1 cancel out.

Here, the crystal grain 21a1 and the crystal grain 19a1 are used as an example. Certainly, the same is true for other crystal grains, for example, the crystal grain 21a2 and the crystal grain 19a2.

With the above structure, it is possible to reduce noise from the second backup layer 18 and improve the S/N ratio of the perpendicular magnetic recording medium 10.

In addition, since the second backup layer 18 functions to absorb and expel the recording magnetic field, and magnetizations of the poly-crystal soft magnetic layer 19 and the poly-crystal soft magnetic layer 21 are coupled by anti-ferromagnetic exchange coupling so that it is possible to further prevent generation of the noise spikes.

Further, generally, it is known that the Wide Area Track Erasure phenomenon is suppressed when the exchange coupling magnetic field is acting between two layers coupled by exchange coupling. Since the poly-crystal soft magnetic layer 19 and the poly-crystal soft magnetic layer 21 of the second backup stack structure 18 are formed from crystal materials, it is possible for the saturation magnetic flux density of the poly-crystal soft magnetic layer 19 and the poly-crystal soft magnetic layer 21 to be higher than that of an amorphous material. When the saturation magnetic flux density is raised, the exchange coupling magnetic field acting between the poly-crystal soft magnetic layer 19 and the poly-crystal soft magnetic layer 21 can be stronger than the exchange coupling magnetic field when using an amorphous magnetic material. As a result, the Wide Area Track Erasure phenomenon is preventable.

It is preferable that the saturation magnetic flux density of the poly-crystal soft magnetic layer 19 and the poly-crystal soft magnetic layer 21 be 1.0 T or higher. Due to this, it is possible to effectively prevent the Wide Area Track Erasure phenomenon from occurring. The upper limit of the saturation magnetic flux density can be any available value. In practice, the maximum saturation magnetic flux density of currently available poly-crystal soft magnetic materials is 2.4 T.

In addition, since the poly-crystal soft magnetic layer 19 and the poly-crystal soft magnetic layer 21 are formed from crystal materials, the saturation magnetic flux density of the poly-crystal soft magnetic layer 19 and the poly-crystal soft magnetic layer 21 formed from crystal materials is higher than that of the same but amorphous material. Due to this, it is possible to set the exchange coupling magnetic field acting between the poly-crystal soft magnetic layer 19 and the poly-crystal soft magnetic layer 21 to be stronger than the exchange coupling magnetic field when using amorphous material; as a result, it is possible to more effectively prevent the Wide Area Track Erasure phenomenon from occurring.

The intermediate layer 22 may be formed from a non-magnetic material having the hcp crystalline structure or the fcc crystalline structure (face centered cubic structure). Specifically, the intermediate layer 22 may be formed from one non-magnetic material including one of Ru, Pd, Pt, and Ru alloys. The Ru alloys are Ru-X2 alloys having the hcp (hexagonal closed packed) crystalline structure, where X2 represents a non-magnetic material including one of Ta, Nb, Co, Cr, Fe, Ni, Mn, O, and C.

When the recording layer 23 is formed from alloys with Co as a major component, it is preferable that the intermediate layer 22 be formed from Ru or Ru-X2 alloys because good lattice matching is obtainable. The (0002) crystal plane of Co grows on the (0002) crystal plane of Ru, and a c axis (easy axis of magnetization) is aligned perpendicular to the substrate.

The intermediate layer 22 may have a structure in which the Ru or Ru-X2 crystal grains (below, referred to as “Ru crystal grains”) are separated from each other by plural interstices. Below, this structure is referred to as “intermediate layer structure A”. Since the Ru crystal grains are nearly uniformly separated from each other, the magnetic particles of the recording layer 23 follow the arrangement of the Ru crystal grains, and this may reduce the range of the distribution of the diameters of the magnetic particles. Hence, the medium noise is reduced, and the SN ratio is raised.

In addition, as described above, since the (0002) crystal plane of Ru grows, when the recording layer 23 is formed from a ferromagnetic material with Co as a major component, the (0002) crystal plane of Co grows, and a c axis (easy axis of magnetization) is aligned perpendicular to the substrate.

Such an intermediate layer 22 can be formed by sputtering. Specifically, with a sputtering target made from Ru or Ru-X2 alloys and in an atmosphere of an inert gas, such as Ar gas, the intermediate layer 22 is sputtered with a deposition speed of 2 nm/s or lower, and the pressure of the atmosphere is 2.66 Pa or higher. However, in order that the production efficiency is not too low, it is preferable for the deposition speed to be higher than 0.1 nm/s. Further, the atmospheric gas may be an inert gas with O₂ gas added at a volume concentration of 2% or less. Due to this, the Ru-crystal grains are well separated.

Alternatively, the intermediate layer 22 may have a structure in which the Ru-crystal grains are enclosed by immiscible layers. Below, this structure is referred to as “intermediate layer structure B”. Even with such a structure, the Ru crystal grains can be nearly uniformly separated from each other, and this may reduce the range of the distribution of the diameters of the magnetic particles. Hence, the medium noise is reduced and the SN ratio is raised.

There is no limitation to the material constituting the immiscible layers as long as the material is not soluble with Ru or Ru alloys. Preferably, the immiscible layer is formed from compounds including at least one of Si, Al, Ta, Zr, Y, Ti, and Mg, and at least one of O, C, and N, for example, SiO₂, Al₂O₃, Ta₂O₃, ZrO₂, Y₂O₃, TiO₂, MgO, or other oxides, or Si₃N₄, AlN, TaN, ZrN, TiN, Mg₃N₂, or other nitrides, or carbides like SiC, TaC, ZrC, TiC.

The recording layer 23 may be formed from a ferromagnetic material including one of Ni, Fe, Ni-alloys, Fe-alloys, Co, and alloys with Co as a major component (below, referred to as “ferromagnetic continuous film”).

For example, the Fe-alloys may be FePt, and the alloys with Co as a major component may be one of CoPt, CoCrTa, CoCrPt, and CoCrPt-M with the atomic content of Co being 50% or more, where M represents at least one of B, Mo, Nb, Ta, W, and Cu. In addition, the CoPt alloys may include CoPt in which the composition ratio of Co and Pt is 1:1, and CO₃Pt in which the composition ratio of Co and Pt is 3:1.

Alternatively, the recording layer 23 may have a structure in which plural magnetic particles are each formed from a ferromagnetic material including one of Ni, Fe, Ni-alloys, Fe-alloys, Co, and alloys with Co as a major component, and the magnetic particles are enclosed by immiscible layers to separate the magnetic particles from each other. Below, this structure is referred to as “ferromagnetic granular structure film”. When the recording layer 23 has a ferromagnetic granular structure film, the magnetic particles can be nearly uniformly separated from each other, and this may reduce the medium noise.

Here, the alloys with Co as a major component may have the same composition as those described above. There is no limitation to the material constituting the immiscible layers as long as the material is not soluble with the magnetic particles. Preferably, the immiscible layer is formed from compounds including at least one of Si, Al, Ta, Zr, Y, Ti, and Mg, and at least one of O, C, and N, for example, SiO₂, Al₂O₃, Ta₂O₃, ZrO₂, Y₂O₃, TiO₂, MgO, or other oxides, or Si₃N₄, AlN, TaN, ZrN, TiN, Mg₃N₂, or other nitrides, or carbides like SiC, TaC, ZrC, TiC.

It is preferable that the second backup stack structure 18, the intermediate layer 22, and the recording layer 23 be combined so as to have the following structure. Specifically, the poly-crystal soft magnetic layer 19 and the poly-crystal soft magnetic layer 21 of the second backup stack structure 18 are formed from Ni or NiFe, the intermediate layer 22 has the above-mentioned intermediate layer structure A or intermediate layer structure B, and the recording layer 23 has the ferromagnetic granular structure film. In this case, it is preferable that the magnetic particles of the ferromagnetic granular structure film be formed from the alloys with Co as a major component, as described above.

With such a combination, the Ru crystal grains of the intermediate layer 22 grow on the crystal grains of the poly-crystal soft magnetic layer 19 and the poly-crystal soft magnetic layer 21 of the second backup stack structure 18; further, the magnetic particles of the recording layer 23 grow on the Ru crystal grains of the intermediate layer 22. Due to this, the range of the distribution of the diameters of the magnetic particles of the recording layer 23 can be reduced, the medium noise can be reduced, and the SN ratio can be improved.

When the poly-crystal soft magnetic layer 19 and the poly-crystal soft magnetic layer 21 of the second backup stack structure 18 are formed from Ni or NiFe, the (111) crystalline plane of Ni or NiFe becomes the growing plane, and the (0002) crystal plane of Ru grows thereon with good lattice matching. Thus, it is possible to improve the crystallinity and the crystalline alignment of the Ru crystal grains. Further, the (0002) crystal plane of Co magnetic particles grows on the (0002) crystal plane of Ru crystal grains with good lattice matching. Hence, it is possible to improve the crystallinity and the crystalline alignment of the magnetic particles. As a result, it is possible to improve the magnetic property of the recording layer 23 of the perpendicular magnetic recording medium 10 and the recording and reproduction property of the perpendicular magnetic recording medium 10.

There is no limitation to the protection film 24. For example, the protection film 24 may be 0.5 nm to 15 nm in thickness, and may be formed from amorphous carbon, carbon hydride, carbon nitride, aluminum oxide, and the like.

There is no limitation to the lubrication layer 25. For example, the lubrication layer 25 may be 0.5 nm to 5 nm in thickness, and may be formed by a lubricant having a main chain of perfluoropolyether. Depending on the materials of the protection film 24, the lubrication layer 18 may be provided or be omitted.

The above layers of the perpendicular magnetic recording medium 10 can be fabricated by sputtering except those described above. During sputtering, sputtering targets made from the materials of the layers are used, and sputtering is performed in an atmosphere of an inert gas, such as Ar gas to deposit the films. When fabricating the films, in order that the amorphous soft magnetic layer 13 and the amorphous soft magnetic layer 15 of the first backup layer 12 are not crystallized, it is preferable that the substrate 11 not be heated. Certainly, the substrate 11 can be heated to a temperature at which the amorphous soft magnetic layers 13 and 15 of the first backup layer 12 are not crystallized, or the substrate 11 can be heated to remove moisture on the surface of the substrate 11 before the amorphous soft magnetic layers 13 and 15 are formed, and then the amorphous soft magnetic layers 13 and 15 are formed after the substrate 11 is cooled.

In the perpendicular magnetic recording medium 10, the second backup layer 18 includes the poly-crystal soft magnetic layer 19 and the poly-crystal soft magnetic layer 21, and the non-magnetic coupling layer 20 in between. Because the poly-crystal soft magnetic layer 19 and the poly-crystal soft magnetic layer 21 are crystals, it is possible to improve the crystallinity and the crystalline alignment of the intermediate layer 22 and the recording layer 23 on the second backup layer 18. This enhances the perpendicular coercive force of the recording layer 23, and the nucleation field of the recording layer 23 is negative and has a large absolute value, thus improving the magnetic property of the recording layer 23.

Further, since the poly-crystal soft magnetic layer 19 and the poly-crystal soft magnetic layer 21 of the second backup layer 18 are coupled by anti-ferromagnetic exchange coupling, the magnetic field leakages from the poly-crystal soft magnetic layer 19 and the poly-crystal soft magnetic layer 21 cancel out each other. Due to this, it is possible to reduce the magnetic field leakage from the second backup layer 18; this reduces noise caused by the second backup layer 18, and prevents noise from being detected by the reproduction element of the magnetic head. As a result, it is possible to perform high density recording in the perpendicular magnetic recording medium 10.

Further, since the poly-crystal soft magnetic layer 19 and the poly-crystal soft magnetic layer 21 are crystals, it is possible for the saturation magnetic flux density of the poly-crystal soft magnetic layer 19 and the poly-crystal soft magnetic layer 21 to be higher than that of an amorphous soft magnetic material; this enhances the exchanging coupling magnetic field and prevents the Wide Area Track Erasure phenomenon from occurring.

Next, another example of the perpendicular magnetic recording medium of the present embodiment is described.

FIG. 3 is a schematic cross-sectional view illustrating another example of a perpendicular magnetic recording medium according to the first embodiment of the present invention.

In FIG. 3, the same reference numbers are used for the same elements as those in the previous example, and overlapping descriptions are omitted.

FIG. 3 shows a perpendicular magnetic recording medium 30, which is nearly the same as the perpendicular magnetic recording medium 10 except that a recording layer 33 of the perpendicular magnetic recording medium 30 includes a first magnetic layer 33a and a second magnetic layer 33b. Both the first magnetic layer 33a and the second magnetic layer 33b may be a ferromagnetic continuous film, or a ferromagnetic granular structure film.

With the recording layer 33 including two magnetic layers, each of the first magnetic layer 33a and the second magnetic layer 33b may be made thin, and this prevents transverse spread of magnetic particles of the first magnetic layer 33a and the second magnetic layer 33b when the magnetic particles grow in the thickness direction; that is, it is possible to prevent an increase in the diameters of the magnetic particles, and this can reduce the medium noise.

In addition, in the recording layer 33, it is preferable that the first magnetic layer 33a be a ferromagnetic continuous film, and the second magnetic layer 33b be a ferromagnetic granular structure film. Since the saturation magnetic flux density of the ferromagnetic continuous film is higher than that of the ferromagnetic granular structure film, if the ferromagnetic continuous film is arranged to be near the reproduction element of the magnetic head, it is possible to increase the reproduction output. Further, since the magnetic particles in the ferromagnetic granular structure film of the second magnetic layer 33a follow the arrangement of the crystal grains of the intermediate layer 22, and the magnetic particles are arranged uniformly in the film, it is possible to reduce the medium noise in the ferromagnetic granular structure film of the second magnetic layer 33a.

Further, since the magnetic particles in the ferromagnetic continuous film of the first magnetic layer 33b follow the arrangement of the magnetic particles in the ferromagnetic granular structure film of the second magnetic layer 33a, the magnetic particles are arranged uniformly in the film, and it is possible to further reduce the medium noise in the ferromagnetic continuous film of the first magnetic layer 33b.

The perpendicular magnetic recording medium 30 has an effect similar to that of the perpendicular magnetic recording medium 10. Further, the perpendicular magnetic recording medium 30 can further reduce the noise of the recording layer 33, and thus it is possible to improve the magnetic property and the recording and reproduction property of the recording layer 33 of the perpendicular magnetic recording medium 30.

It should be noted that the number of the magnetic layers in the recording layer 33 is not limited to two, but may be three or more, as described below.

FIG. 4 is a schematic cross-sectional view illustrating still another example of a perpendicular magnetic recording medium according to the first embodiment of the present invention.

In FIG. 4, the same reference numbers are used for the same elements as those in the previous examples, and overlapping descriptions are omitted.

FIG. 4 shows a perpendicular magnetic recording medium 40, which is nearly the same as the perpendicular magnetic recording medium 10 except that a recording layer 43 of the perpendicular magnetic recording medium 40 includes n magnetic layers 43₁ to 43ₙ, where n is a natural number.

Each of the first magnetic layers 43₁ to n-th magnetic layers 43ₙ may be a ferromagnetic continuous film or a ferromagnetic granular structure film, which are used in the perpendicular magnetic recording medium 10 as described above.

With the recording layer 43 including n magnetic layers, each of the magnetic layers may be made very thin, and this prevents transverse spread of magnetic particles of the magnetic layers when the magnetic particles grow in the thickness direction, that is, it is possible to prevent an increase in the diameters of the magnetic particles. This can reduce the medium noise in the recording layer 43, and improve the SN ratio.

Certainly, the perpendicular magnetic recording medium 40 has an effect similar to that of the perpendicular magnetic recording medium 10.

Below, examples of the perpendicular magnetic recording media of the present embodiment are provided.

### EXAMPLE 1

As the first example of the present embodiment, a perpendicular magnetic recording medium was fabricated as described below. The perpendicular magnetic recording medium of this example has the same structure as that of the perpendicular magnetic recording medium 30 in FIG. 3. Thus, in the following, the same reference numbers are used as in FIG. 3. The figures in parentheses are film thicknesses.

Specifically, the perpendicular magnetic recording medium of this example includes the following components.

A substrate 11: glass substrate,

A first backup layer 12:
amorphous soft magnetic layers 13, 15: CoNbZr films (each film 25 nm),
a non-magnetic coupling layer 14: Ru film (0.6 nm),

A separation layer 16: Ta film (3 nm)

A second backup layer 18:
poly-crystal soft magnetic layers 19, 21: Ni₈₀Fe₂₀ film,
a non-magnetic coupling layer 20: Ru film (0.6 nm),

An intermediate layer 22: Ru film (20 nm)

A recording layer 23:
a first magnetic layer 33a: CoCrPt—SiO₂ film (10 nm),
a second magnetic layer 33b: CoCrPtB film (6 nm),

A protection film 24: carbon film (3 nm)

A lubrication layer 25: perfluoropolyether (1.5 nm).

The perpendicular magnetic recording medium of this example was fabricated in the following way. A cleaned glass substrate 11 was conveyed to a sputtering chamber, and the above films were formed by using a DC magnetron without heating the substrate 11 with an Ar gas being introduced into the chamber and being set at a pressure of 0.7 Pa.

Magnetic disks having different thicknesses of the Ni₈₀Fe₂₀ films, which serve as the poly-crystal soft magnetic layers 19, 21 of the second backup layer 18, were fabricated.

Specifically, the thickness of the Ni₆₀Fe₂₀ film was 3 nm, 5 nm, 8 nm, 10 nm, and 15 nm. For the purpose of comparison, a magnetic disk without the Ni₈₀Fe₂₀ film was also fabricated.

Crystalline alignment of the above Ni₈₀Fe₂₀ films, Ru films, CoCrPt—SiO₂ film and CoCrPtB film of these magnetic disks were investigated by an X-ray diffraction spectrometer through θ-2θ scan using a Cu—Kα X-ray source.

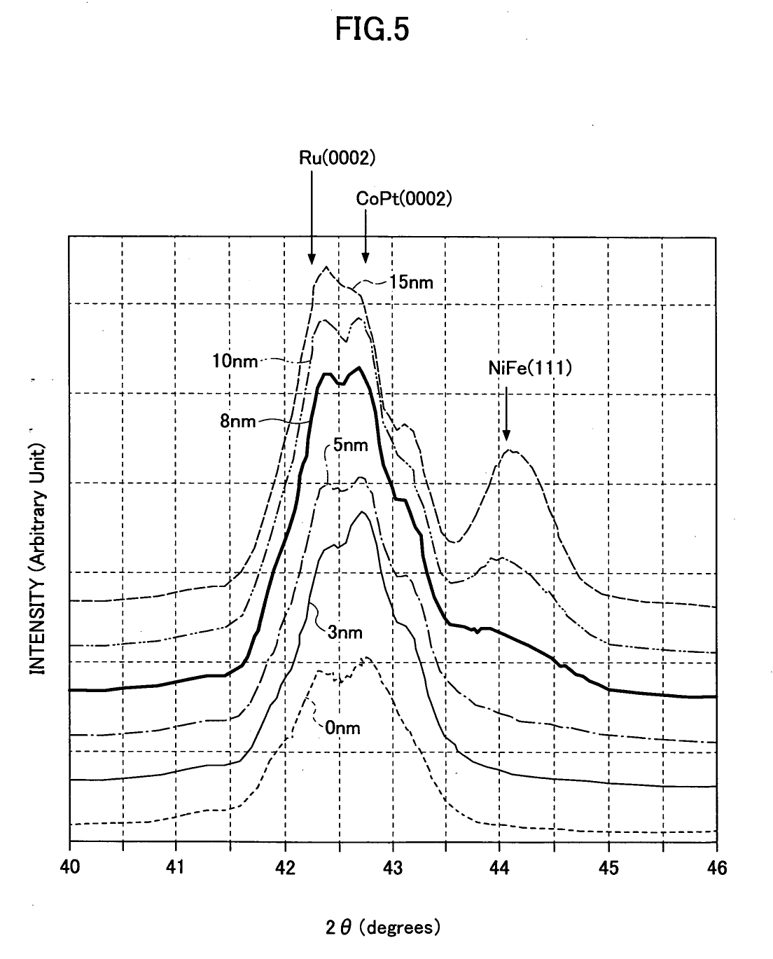

FIG. 5 shows experimental results of X-ray diffraction on crystal orientation of the perpendicular magnetic recording medium of the present example.

In FIG. 5, the (0002) crystalline plane of Ru appears at 2θ=42.25 degrees, the (0002) crystalline plane of CoPt appears at 2θ=42.75 degrees, and the (111) crystalline plane of NiFe appears at 2θ=44.14 degrees.

Referring to FIG. 5, the intensity of the diffracted rays corresponding to the (0002) crystalline plane of Ru and the (0002) crystalline plane of CoPt is higher when the Ni₆₀Fe₂₀ films were provided in the magnetic disks than that when the Ni₈₀Fe₂₀ film was not provided in the magnetic disk. This reveals that crystalline alignment of the Ru films, the CoCrPt component in the CoCrPt—SiO₂ film, and the CoCrPtB film was improved when the Ni₈₀Fe₂₀ films were provided.

In addition, with an increased thickness of the Ni₈₀Fe₂₀ films, the intensity of the diffracted rays corresponding to the (111) crystalline plane of NiFe rises drastically, indicating that crystalline alignment of the Ni₈₀Fe₂₀ films was improved greatly. Accordingly, the intensity of the diffracted rays corresponding to the (0002) crystalline plane of Ru and the (0002) crystalline plane of CoPt rises. This reveals that by adjusting crystalline alignment of the Ni₈₀Fe₂₀ films, it is possible to adjust the crystalline alignment of the (0002) crystalline plane of Ru and the (0002) crystalline plane of CoPt. Especially, when the thickness of the Ni₈₀Fe₂₀ films was equal to or greater than 3 nm, the intensity of the diffracted rays corresponding to the (0002) crystalline plane of Ru and the (0002) crystalline plane of CoPt is much higher when the Ni₈₀Fe₂₀ films were provided than that when the Ni₈₀Fe₂₀ film was not provided. This is a preferable structure.

### EXAMPLE 2

As the second example of the present embodiment, a perpendicular magnetic recording medium was fabricated as described below. The perpendicular magnetic recording medium of this example has the same structure as that of the perpendicular magnetic recording medium 30 in FIG. 3. Thus, in the following, the same reference numbers are used as in FIG. 3. The figures in parentheses are film thicknesses.

Specifically, the perpendicular magnetic recording medium of this example includes the following components.

A substrate 11: glass substrate,

A first backup layer 12:
amorphous soft magnetic layers 13, 15: CoNbZr films (each film 25 nm),
a non-magnetic coupling layer 14: Ru film (0.6 nm),

A separation layer 16: Ta film (3 nm)

A second backup layer 18:
poly-crystal soft magnetic layers 19, 21: Ni₈₀Fe₂₀ film (5 nm),
a non-magnetic coupling layer 20: Ru film (0.6 nm),

An intermediate layer 22: Ru film (20 nm)

A recording layer 23: (total thickness of the first magnetic layer 33a and the second magnetic layer 33b is 16 nm)
a first magnetic layer 33a: CoCrPt—SiO₂ film,
a second magnetic layer 33b: CoCrPt film,

A protection film 24: carbon film (4.5 nm)

A lubrication layer 25: perfluoropolyether (1.5 nm).

The perpendicular magnetic recording medium of this example was fabricated in the same way as the example 1.

For the purpose of comparison, a magnetic disk without the stack structure of the Ni₈₀Fe₂₀ film, the Ru film, and the Ni₈₀Fe₂₀ film of the second backup layer 18 was fabricated (this is referred to as “example for comparison 1”). In addition, a magnetic disk in which the second backup layer 18 has only one Ni₈₀Fe₂₀ film, but not the Ru film and the Ni₆₀Fe₂₀ film was fabricated (this is referred to as “example for comparison 2”).

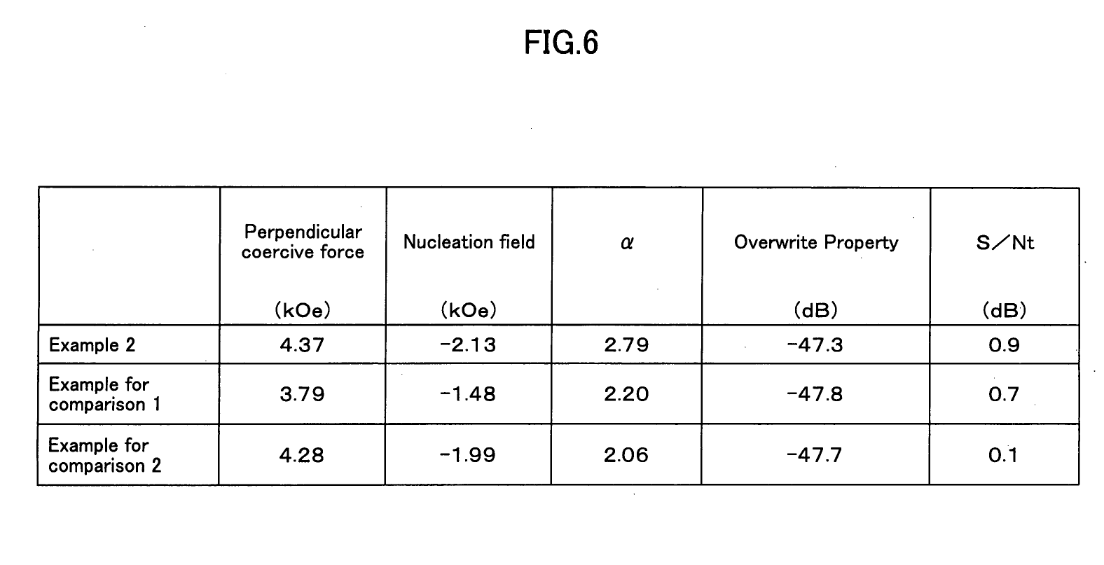

FIG. 6 is a table showing properties of the perpendicular magnetic recording medium of the present example and examples for comparison 1 and 2.

FIG. 6 shows magnetic properties of the perpendicular coercive force, the nucleation field, and a parameter α. The perpendicular coercive force, the nucleation field, and α, were calculated from the hysteresis loop of the Kerr rotation angle, which was obtained by applying a magnetic field in a direction perpendicular to the substrate. The nucleation field corresponds to the applied magnetic field which results in the tangential line of the hysteresis loop, which hysteresis loop is obtained when applying a magnetic field so that the Kerr rotation angle is zero, to be at the Kerr rotation angle when the applied magnetic field is zero. The parameter α indicates the inclination of the hysteresis loop when a magnetic field is applied so that the Kerr rotation angle is zero.

In the present example, the perpendicular coercive force is stronger than in the examples for comparison 1 and 2. The nucleation field is negative and has a larger absolute value than in the examples for comparison 1 and 2, indicating that the squareness of the hysteresis loop is good. In addition, the parameter α is comparable to those in the examples for comparison 1 and 2. This reveals that crystalline alignment of the (0002) crystalline plane of CoPt in the recording layer was improved, and the magnetic property was improved when the stack structure of the Ni₈₀Fe₂₀ film, the Ru film, and the Ni₈₀Fe₂₀ film of the second backup layer 18 was provided.

In addition, overwrite property and S/Nt were measured by using a commercially available spin stand and a composite magnetic head having an induction recording element, which performs in-plane magnetic recording, and a GMR (Giant Magneto-Resistive) element. Here, S represents an average output at 495 kBPI, and Nt represents the noise including both the medium noise and the device noise. The value of S/Nt is shown by a ratio to a specified magnetic disk (standard medium).

As shown in FIG. 6, the overwrite property is −47 dB, which is comparable to those in the examples for comparison 1 and 2. In other words, although the perpendicular coercive force in the present example is higher than that in the example for comparison 1 by 500 Oe, degradation of the overwrite property does not occur. This reveals that crystalline alignment of the recording layer was improved.

In addition, the value of S/Nt is much higher than those in the example for comparison 2. This reveals that with the stack structure of the Ni₈₀Fe₂₀ film, the Ru film, and the Ni₈₀Fe₂₀ film of the second backup layer 18 being provided instead of a second backup layer having only one Ni₈₀Fe₂₀ film, magnetic field leakage was reduced, and the value of S/Nt is increased.

### Second Embodiment

This embodiment relates to a magnetic storage device using the perpendicular magnetic recording media of the previous embodiment.

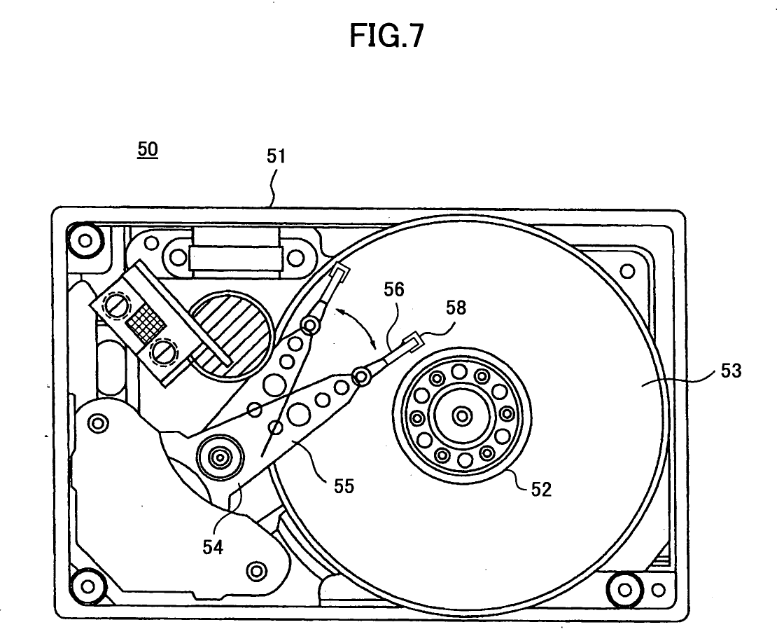

FIG. 7 is a schematic view of a principal portion of a magnetic storage device 50 according to a second embodiment of the present invention.

As illustrated in FIG. 7, the magnetic storage device 50 includes a housing 51, and in the housing 51 there are arranged a hub 52 driven by a not-illustrated spindle, a perpendicular magnetic recording medium 53 rotably fixed to the hub 52, an actuator unit 54, an arm 55 attached to the actuator unit 54 and movable in a radial direction of the perpendicular magnetic recording medium 53, a suspension 56, and a magnetic head 58 supported by the suspension 56.

For example, the magnetic head 58 has a reproduction head, which has a single-pole recording head and a GMR (Giant Magneto-Resistive) element.

Although not illustrated, the single-pole recording head includes a main magnetic pole formed from a soft magnetic material for applying a recording magnetic field on the perpendicular magnetic recording medium 53, a return yoke magnetically connected to the main magnetic pole, and a recording coil for guiding the recording magnetic field to the main magnetic pole and the return yoke. The single-pole recording head applies a recording magnetic field on the perpendicular magnetic recording medium 53 from the main magnetic pole in the perpendicular direction, and magnetizes the perpendicular magnetic recording medium 53 in the perpendicular direction.

Although not illustrated, the reproduction head has a GMR element. The GMR element is able to detect magnetic field leakage of magnetizations of the perpendicular magnetic recording medium 53, and obtains the data recorded in the perpendicular magnetic recording medium 53 according to variation of a resistance of the GMR element corresponding to the direction of the detected magnetic field. It should be noted that instead of the GMR element, a TMR (Ferromagnetic Tunnel Junction Magneto-Resistive) element can be used.

In the magnetic storage device 50, the perpendicular magnetic recording media of the previous embodiment are used as the perpendicular magnetic recording medium 53. Hence, the perpendicular magnetic recording medium 53 is of a good SN ratio and is able to prevent the Wide Area Track Erasure phenomenon.

It should be noted the configuration of the magnetic storage device 50 is not limited to that shown in FIG. 7, and the magnetic head 58 is not limited to the above configuration, either. Any well-known magnetic head can be used. Further, the perpendicular magnetic recording medium 53 is not limited to magnetic disks; it may also be magnetic tapes.

According to the present embodiment, it is possible to realize high density recording and the long-term reliability of the perpendicular magnetic recording medium, and prevent the Wide Area Track Erasure phenomenon.

While the invention is described above with reference to specific embodiments chosen for purpose of illustration, it should be apparent that the invention is not limited to these embodiments, but numerous modifications could be made thereto by those skilled in the art without departing from the basic concept and scope of the invention.

What is claimed is:

1. A perpendicular magnetic recording medium, comprising:
a substrate;
a soft-magnetic backup stack structure including a first magnetic layer, a first non-magnetic coupling layer, and a second magnetic layer stacked on the substrate in order;
an intermediate layer formed from a non-magnetic material on the soft-magnetic backup stacked structure; and
a recording layer on the intermediate layer, said recording layer having an easy axis of magnetization perpendicular to the surface of the substrate;
wherein
the first magnetic layer and the second magnetic layer are formed from a poly-crystal soft-magnetic material, and
each of the first magnetic layer and the second magnetic layer has an easy axis of magnetization in the surface thereof, and a magnetization of the first magnetic layer and a magnetization of the second magnetic layer are coupled, the magnetizations being anti-parallel to each other.

2. The perpendicular magnetic recording medium as claimed in claim 1, wherein
a magnetization of a crystal grain of the first magnetic layer is anti-parallel to a magnetization of a crystal grain of the second magnetic layer.

3. The perpendicular magnetic recording medium as claimed in claim 1, further comprising:
another soft-magnetic backup stack structure disposed between the substrate and the soft-magnetic backup stack structure;
wherein
the other soft-magnetic backup stack structure includes a third magnetic layer, a fourth magnetic layer stacked on the third magnetic layer, and a second non-magnetic coupling layer in between,
the third magnetic layer and the fourth magnetic layer are formed from an amorphous soft-magnetic material, and
each of the third magnetic layer and the fourth magnetic layer has an easy axis of magnetization in the surface thereof, and a magnetization of the third magnetic layer and a magnetization of the fourth magnetic layer are coupled, the magnetizations being anti-parallel to each other.

4. The perpendicular magnetic recording medium as claimed in claim 3, wherein
the substrate is disk-shaped,
the crystal grain of the first magnetic layer and the crystal grain of the second magnetic layer are formed such that easy axes of magnetization thereof are randomly oriented, and
the crystal grain of the third magnetic layer and the crystal grain of the fourth magnetic layer are formed such that easy axes of magnetization thereof are parallel to a radial direction of the substrate.

5. The perpendicular magnetic recording medium as claimed in claim 1, further comprising:
a separation layer below the soft-magnetic backup stack structure;
wherein
the separation layer is formed from an amorphous non-magnetic material including at least one of Ta, Zr, Ti, C, Mo, W, Re, Os, Hf, Mg, and Pt.

6. The perpendicular magnetic recording medium as claimed in claim 1, wherein the intermediate layer has a hcp crystalline structure or a fcc crystalline structure.

7. The perpendicular magnetic recording medium as claimed in claim 6, wherein the intermediate layer is formed from a material including at least one of Ru, Pd, Pt, and a Ru-X2 alloy, where X2 represents a non-magnetic material including one of Ta, Nb, Co, Cr, Fe, Ni, Mn, O, and C.

8. The perpendicular magnetic recording medium as claimed in claim 6, wherein
the intermediate layer includes a plurality of crystal grains each growing in a direction perpendicular to the surface of the substrate, and
the crystal grains are separated from each other by a plurality of interstices or immiscible phases.

9. The perpendicular magnetic recording medium as claimed in claim 8, wherein each of the crystal grains of the intermediate layer is formed from a material including at least one of Ru and a Ru-X2 alloy, where X2 represents a non-magnetic material including one of Ta, Nb, Co, Cr, Fe, Ni, Mn, and C.

10. The perpendicular magnetic recording medium as claimed in claim 1, wherein
each of the first magnetic layer and the second magnetic layer in the soft-magnetic backup stack structure is formed from one of Ni, NiFe, and NiFe-X1, where X1 represents a non-magnetic material including one of Cr, Ru, Si, O, N, and SiO₂.

11. The perpendicular magnetic recording medium as claimed in claim 1, wherein
each of the first magnetic layer and the second magnetic layer of the soft-magnetic backup stack structure has a saturation magnetic flux density equal to or greater than 1 T.

12. The perpendicular magnetic recording medium as claimed in claim 1, wherein
the first non-magnetic coupling layer of the soft-magnetic backup stack structure is formed from one of Ru, Cu, Cr, Rh, Ir, a Ru alloy, a Rh alloy, and an Ir alloy.

13. The perpendicular magnetic recording medium as claimed in claim 12, wherein
the intermediate layer is formed from Ru or a Ru alloy, and
the intermediate layer is formed by growing a (0002) crystalline plane epitaxially on a (111) crystalline plane of the second magnetic layer.

14. The perpendicular magnetic recording medium as claimed in claim 1, wherein
the recording layer is formed from a ferromagnetic material including one of Ni, Fe, a Ni-alloy, a Fe-alloy, Co, and an alloy with Co as a major component.

15. The perpendicular magnetic recording medium as claimed in claim 1, wherein
the recording layer is a continuous film formed from a ferromagnetic material including one of Ni, Fe, a Ni-alloy, a Fe-alloy, Co, and an alloy with Co as a major component.

16. The perpendicular magnetic recording medium as claimed in claim 1, wherein
the recording layer includes a plurality of magnetic particles each formed from a ferromagnetic material including one of Ni, Fe, a Ni-alloy, a Fe-alloy, Co, and an alloy with Co as a major component, and
the magnetic particles are separated from each other by a plurality of interstices or immiscible layers.

17. The perpendicular magnetic recording medium as claimed in claim 1, wherein
the recording layer includes a first hard magnetic layer and a second hard magnetic layer stacked on the substrate in order,
the first hard magnetic layer includes a plurality of magnetic particles each formed from an alloy with Co as a major component, and the magnetic particles in the first hard magnetic layer are separated from each other by a plurality of interstices or immiscible layers, and
the second hard magnetic layer is a continuous film formed from an alloy with Co as a major component.

18. The perpendicular magnetic recording medium as claimed in claim 14, wherein the alloy with Co as a major component includes one of CoPt, CoCrTa, CoCrPt, and CoCrPt-M, where, M represents at least one of B, Mo, Nb, Ta, W, and Cu.

19. A magnetic storage device, comprising:
a recording and reproduction unit having a magnetic head; and
a perpendicular magnetic recording medium;
wherein
the perpendicular magnetic recording medium includes
a substrate;
a soft-magnetic backup stack structure including a first magnetic layer, a first non-magnetic coupling layer, and a second magnetic layer stacked on the substrate in order;
an intermediate layer formed from a non-magnetic material on the soft-magnetic backup stacked structure; and
a recording layer on the intermediate layer, said recording layer having an easy axis of magnetization perpendicular to the surface of the substrate;
wherein
the first magnetic layer and the second magnetic layer are formed from a poly-crystal soft-magnetic material, and
each of the first magnetic layer and the second magnetic layer has an easy axis of magnetization in the surface thereof, and a magnetization of the first magnetic layer and a magnetization of the second magnetic layer are coupled, the magnetizations being anti-parallel to each other.
